(19) United States
(12) Patent Application Publication
(10) Pub. No.: US 2014/0337011 A1
(43) Pub. Date: Nov. 13, 2014

(54) CONTROLLING LANGUAGE TENSE IN ELECTRONIC CONTENT

(71) Applicant: International Business Machines Corporation, Armonk, NY (US)

(72) Inventors: Paul R. Bastide, Boxford, MA (US); Matthew E. Broomhall, Goffstown, NH (US); Robert E. Loredo, North Miami Beach, FL (US)

(73) Assignee: International Business Machines Corporation, Armonk, NY (US)

(21) Appl. No.: 13/893,221

(22) Filed: May 13, 2013

(51) Int. Cl. G06F 17/28

(52) U.S. Cl. CPC G06F 17/28
USPC 704/9

(57) ABSTRACT

Controlling language tense in electronic content includes determining that an age of language in electronic content exceeds a language change time threshold and changing the language to reflect a current time in response to exceeding the language change time threshold.

### BACKGROUND

The present invention relates to controlling language tense in electronic content, and more specifically, to controlling language tense in social networking applications.

Networks are used to transmit, access, upload, and retrieve electronic content stored on servers to user devices. A network may use severs to store electronic content, such as news articles, updates from social network services, emails, and other forms of electronic content that can be displayed to a user. A user may use a user device to access a network to transmit, access, upload, and retrieve the electronic content stored on the servers. Further, electronic content is often written for events that are currently occurring or will happen in the future such as astronomical events, social events, scheduled sporting events, or other types of events.

### BRIEF SUMMARY

A computer program product includes a computer readable storage medium, the computer readable storage medium having computer readable program code embodied therewith. The computer readable program code having computer readable program code to determine that an age of language in electronic content exceeds a language change time threshold and to change the language to reflect a current time in response to exceeding the language change time threshold.

A system for controlling language tense in electronic content includes an identification engine to identify text symbols that reflect time in language of electronic content in a display, an assignment engine to assign time thresholds to the text symbols identified to reflect the time, an age determination engine to determine an age of the language, and a changing engine to change a time expired text symbol of the text symbols to reflect a current time in response to exceeding at least one of the time thresholds.

A system for controlling language tense in electronic content includes an identification engine to identify text symbols that reflect tense of language of electronic content, an age determination engine to determine an age of the language, and a changing engine to change a tense of the language to reflect a current time in response to exceeding a time threshold assigned to one of the text symbols.

A method for controlling language tense in electronic content includes determining that an age of language in electronic content in a display exceeds a language change time threshold and changing the language to reflect a current time in response to exceeding the language change time threshold.

A method for controlling language tense in electronic content includes identifying terms that reflect time in language in electronic content in a display, assigning time thresholds to the text symbols identified to reflect time, and changing the language to reflect a current time in response to exceeding one of the time thresholds.

A method for controlling language tense in electronic content includes identifying text symbols that reflect a tense of language of electronic content, assigning time thresholds to the text symbols identified to reflect the tense, determining an age of the language in the electronic content, and changing a tense of the language to reflect a current time in response to exceeding at least one of the time threshold.

### BRIEF DESCRIPTION OF THE SEVERAL VIEWS OF THE DRAWINGS

The accompanying drawings illustrate various examples of the principles described herein and are a part of the specification. The examples do not limit the scope of the claims.

FIG. 1 is a diagram of an example of a system for controlling language tense in electronic content, according to one example of principles described herein.

FIG. 2 is a diagram of an example for controlling language tense in electronic content, according to one example of principles described herein.

FIG. 3 is a diagram of an example for controlling language tense in electronic content, according to one example of principles described herein.

FIG. 4 is a diagram of an example of a term library for controlling language tense in electronic content, according to one example of principles described herein.

FIG. 5 is a flowchart of an example of a method for controlling language tense in electronic content, according to principles described herein.

FIG. 6 is a flowchart of an example of a method for controlling language tense in electronic content, according to principles described herein.

FIG. 7 is a diagram of an example of a control system, according to the principles described herein.

FIG. 8 is a diagram of an example of a control system, according to the principles described herein.

Throughout the drawings, identical reference numbers designate similar, but not necessarily identical, elements.

### DETAILED DESCRIPTION

The present specification describes a system and a method for controlling language tense in electronic content stored on a network such that the language tense reflects a current time.

As will be appreciated by one skilled in the art, aspects of the present specification may be embodied as a system, method, or computer program product. Accordingly, aspects of the present specification may take the form of hardware or a combination of hardware and software. Furthermore, aspects of the present specification may take the form of a computer program product embodied in a number of computer readable mediums having computer readable program code embodied thereon.

Any combination of computer readable medium(s) may be utilized. A computer readable storage medium may be, for example, but not limited to, an electronic, magnetic, optical electromagnetic, infrared, or semiconductor system, apparatus, or device or any suitable combination of the foregoing. More specific examples (a non-exhaustive list) of the computer readable mediums would include the following: an electrical connection having a number of wires, a portable computer diskette, a hard disk, a random access memory (RAM), a read-only memory (ROM), an erasable programmable read-only memory (EPROP or Flash memory), an optical fiber, a portable compact disk read-only memory (CD-ROM), an optical storage device, a magnetic storage device, or any suitable combination of the foregoing. In the context of this document, a computer readable storage medium may be any tangible medium that can contain, or store a program for use by or in connection with any instruction execution system, apparatus, or device such as, for example, a processor.

Program code embodied on a computer readable medium may be transmitted using any appropriate medium, including but not limited to wireless, wire line, optical fiber cable, RF, etc., or any suitable combination of the foregoing.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Computer program code for carrying out operations of the present specification may be written in an object oriented programming language such as Java, Smalltalk, or C++, among others. However, the computer program code for carrying out operations of the present systems and methods may also be written in procedural programming languages, such as, for example, the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, thought the internet using an internet service provider).

Flowchart illustrations and/or block diagrams of methods, apparatus, and computer program products are disclosed. Each block of the flowchart illustrations and/or block diagrams, and combinations of blocks in the flowchart illustrations and/or block diagrams, can be implemented by computer program instructions. These computer program instructions may be provided to a processor or other programmable data processing apparatus to produce a machine, such that the instructions, which execute via a processor of the computer or other programmable data processing apparatus, implement the functions/acts specified in the flowchart and/or block diagram block or blocks.

In one example, these computer program instructions may be stored in a computer-readable memory that can direct a computer or other programmable data processing apparatus to function in a particular manner, such that the instructions stored in the computer-readable memory produce an article of manufacture including instructions which implement the functions/act specified in the flowchart and/or block diagram blocks or blocks.

The computer program instructions may also be loaded onto a computer or other programmable data processing apparatus to cause a series of operations to be performed on the computer or other programmable apparatus to produce a computer implement process such that the instructions which execute on the computer or other programmable apparatus implement the functions/acts specified in the flowchart and/or block diagram blocks or blocks.

As noted above, electronic content can be written for events that will happen in the future. However, the electronic content written for such future events becomes outdated over time because the future tense of the electronic content's tense is no longer valid when the event is currently occurring or after the event is over. As a result, the tense of the electronic content can cause users confusion.

To make electronic content up-to-date, the electronic content can be manually removed from a server on the network or manually updated by rewriting the electronic content to reflect the correct language tense. Once the electronic content is manually updated, the electronic content can be uploaded to the server on the network. However, manually removing, editing, and/or uploading the electronic content can be time consuming. As a result, an organization that provides a large amount of electronic content can invest significant resources into updating their electronic content.

The principles described herein include a system and a method for controlling language tense in electronic content automatically. The system and method change the language in the electronic content to reflect a current time if the original content's language fails to reflect the current time. For example, the method or system can change the tense of the language to reflect the current time as appropriate.

In one example, a system for controlling language tense in electronic content includes a control system. The control system is in communication with a network to control language tense in electronic content. The electronic content may be viewed on a display on a user device. Further, the control system changes the tense of language in the electronic content from future, to present, to past based on the date and time that the event occurs relative to the present moment.

The control system identifies text symbols that reflect time in language in electronic content. Text symbols can include terms, phrases, n-grams, numbers, structures from the field of natural processing language, other text symbols, or combinations thereof. In one example, identifying the text symbols in electronic content includes identifying time of day terms, time of week terms, time of year terms, age terms, due date terms, verb terms, or combinations thereof. As will be described below, the control system is in communication with a library that contains text symbols that reflect time. As a result, the library is used to identify text symbols in electronic content that reflect time.

The control system also assigns a recommended time threshold to the text symbols identified in the electronic content that reflect time. As will be described below, a recommended time threshold may be independent of time, have a variable time-duration, or a fixed time. Further, a recommended time threshold may be determined by referencing the library. The library may contain recommended time thresholds for text symbols contained in the library. As a result, the library can be used to assign a recommended time threshold to the appropriate text symbols identified in the electronic content.

The control system can also determine that an age of language in electronic content in a display exceeds a language change time threshold. Such threshold can be assigned to the appropriate text symbols in the language. In response to exceeding the time thresholds, the control system can make a change to the language to occur to reflect current time. In one example, determining that an age of language in electronic content in a display exceeds a language change time threshold includes measuring a recorded time stamp from when the text symbols originated in the electronic content to the current time. As will be described below, other factor may be used to determine whether an age of language exceeds a language change time threshold.

The control system changes the language in the electronic content to reflect a current time in response to exceeding the language change time threshold. In one example, the control system changes the language in the electronic content to reflect a current time in response to exceeding a language change time threshold, which is a time threshold assigned to text symbols based on the text symbols' characteristics and when a change to the text symbol will be made to reflect the passage of time. In such an example, identified text symbols in the electronic contest are changed using a library that contains a recommended change based on an expiration of a recommended time threshold for the text symbols in the electronic content.

The present specification also describes a system for controlling language tense in electronic content that includes an identification engine to identify text symbols that reflect time in electronic content in a display, an assignment engine to assign time thresholds to the text symbols identified to reflect the tense of the language, an age determination engine to determine an age of the text symbols, and a changing engine to change a time expired term of the text symbols to reflect a current time in response to exceeding at least one of the time thresholds.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

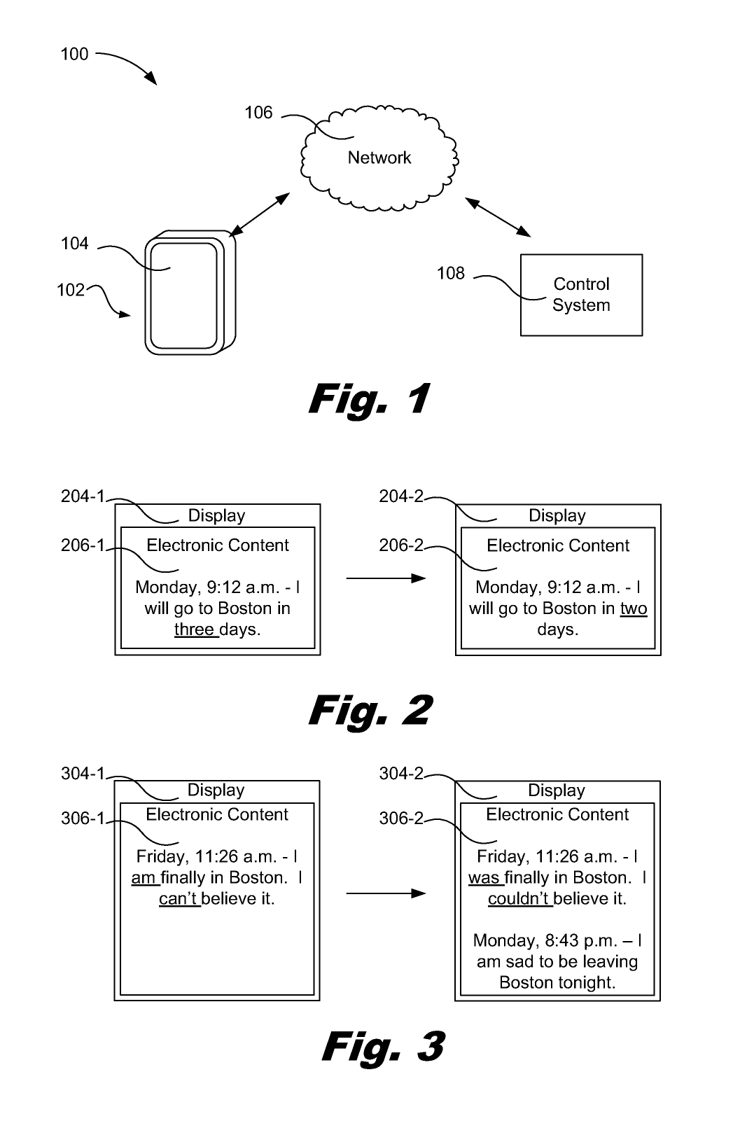

Referring now to the figures, FIG. 1 is a diagram of an example of a system for controlling language tense in electronic content, according to one example of principles described herein. As mentioned above, a control system is in communication with a network to control language tense in electronic content that may be viewed on a display on a user device. Further, the control system changes the tense of language in electronic content from future tense to present tense and/or past tense based the on the date and time that the event occurs relative to the present moment.

As mentioned above, the system (100) includes a user device (102) with a display (104). In one example, a user uses the user device (102) to access a network (106). Further, the display (104) displays electronic content from the network (106). In one example, the network (106) may include a social network server. In this example, the social network server stores, in memory, a social network service. In keeping with the example, the social network service includes an activity stream to display electronic content shared by other users. As will be described below, the language in the electronic content of the activity stream changes to conform to a recommended time threshold for the terms in the electronic content.

The system (100) further includes a control system (108). In keeping with the given example, the control system (108) changes the language in the electronic content of the activity stream to conform to a recommended time threshold for the terms in the electronic content. As will be described below, the control system (108) identifies text symbols that reflect time in the electronic content's language. Text symbols refer to terms, phrases, n-grams, structures from the field of natural processing language, numbers, other text symbols, or combinations thereof. The control system (108) also assigns a time threshold to the text symbols identified to reflect time. Next, the control system (108) determines that an age of language in the electronic content in a display (104) exceeds a language change time threshold. Finally, the control system (108) changes the language to reflect a current time in response to exceeding the language change time threshold. The control system (108) will be described in more detail below.

The principles described herein are well suited for social networking applications that are used on mobile devices. However, any appropriate field of use may incorporate the principles described herein. For example, the principles described herein may also be used in email applications, instant messaging applications, or combinations thereof,

While this example has been described with reference to the control system being located over the network, the control system may be located in any appropriate location according to the principles described herein. For example, the control system may be located in the user device. In some examples, the control system controls just the language that is displayed with the user device. In other examples, the control system controls the language displayed in other user devices of a network. In yet other examples, the control system can control language displayed in some user device specific programs or network programs while not in other programs. For example, the control system may control the language of electronic content in one social networking program while not controlling the language of the electronic content in another social networking program.

FIG. 2 is a diagram of an example for controlling language tense in electronic content, according to one example of principles described herein. As mentioned above, a user uses a user device to access a network. Further, a display on the user device is used to display electronic content from the network. Further, a control system changes the language of the electronic content to conform to a time threshold. As will be described below, changing the language in electronic content to reflect a current time in response to exceeding a language change time threshold includes changing numbers in the electronic content.

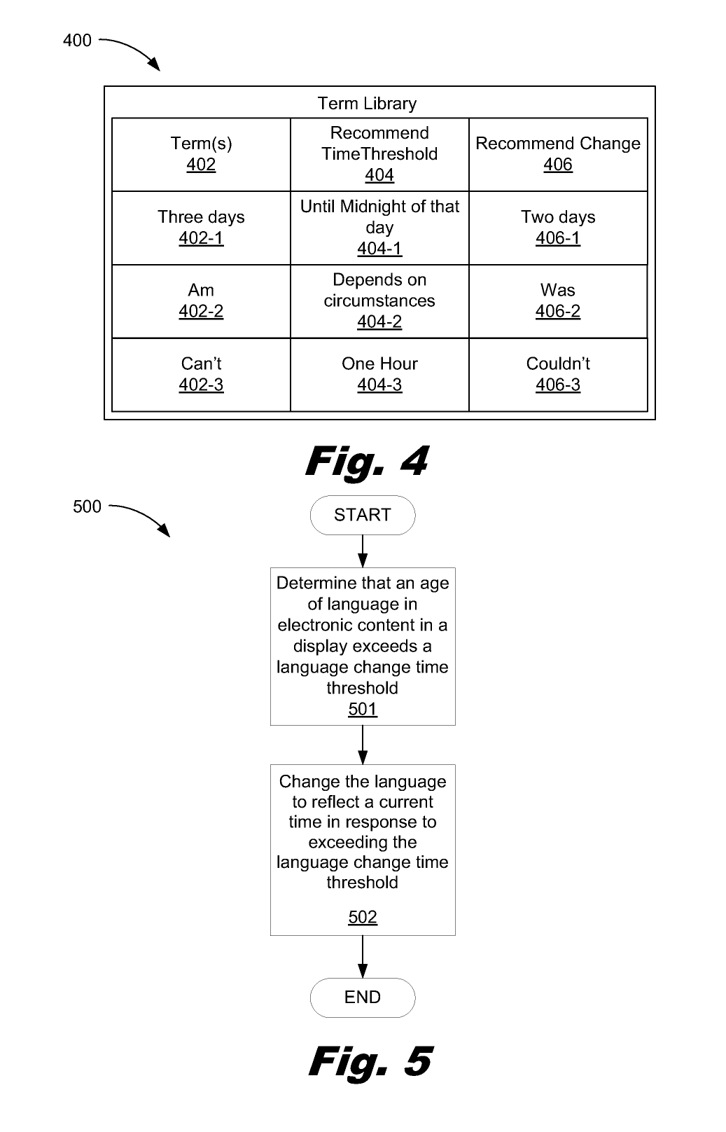

Turning specifically to FIG. 2, a display (204-1) on a user device is used to display electronic content from the network. In one example, a user reads electronic content (206-1) in a display (204-1) that states, “I will go to Boston in three days.” The electronic content (206-1) was posted on a social network service on Monday at 9:12 a.m. As a result, the electronic content (206-1) has a timestamp of Monday 9:12 a.m. In this example, a control system identifies text symbols in the electronic content's language that reflect time. In this example, the term “three” is identified by the control system to reflect time in the electronic content (206-1). As will be described in FIG. 4, the control system can reference a library to identify text symbols that reflect in the electronic content (206-1) or use another mechanism to identify text symbols.

The control system can assign a time thresholds to the text symbols identified to reflect the time. In this example, the term “three” is assigned a time threshold until midnight of the day that the term “three” was originally posted. As will be described in FIG. 4, the library can also be used to assign a time threshold to the text symbols identified in the electronic content (206-1).

In keeping with the given example, a user can access the electronic content (206-1) one day later. The control system determines that an age of the language in electronic content (206-2) in the display (204-2) exceeds a language change time threshold and changes the language to reflect a current time in response to exceeding the language change time threshold. In this example, the term “three” is changed to “two” to reflect a current time in response to exceeding the language change time threshold. As will be described in FIG. 4, the control system can reference a library to determine a recommended change for the text symbols identified in the electronic content (206-1).

As a result, the control system changes the electronic content (206) to reflect a current time. Thus, user confusion is reduced when accessing the electronic content (206) after enough time has past that the text symbols in the language are out of date.

FIG. 3 is a diagram of an example for controlling language tense in electronic content, according to one example of principles described herein. As mentioned above, a user uses a user device to access a network. Further, a display on the user device is used to display electronic content from the network. Further, a control system changes the electronic content to conform to a time threshold for the electronic content. As will be described below, changing the language to reflect a current time in response to exceeding the language change time threshold includes changing verb tenses in the electronic content.

Turning specifically to FIG. 3, a display on a user device is used to display electronic content from the network. In one example, a user reads electronic content (306-1) in a display (304-1) that states, “I am finally in Boston. I can't believe it.” In keeping with the example, the electronic content (306-1) was posted on a social network service on Friday at 11:26 a.m. As a result, the electronic content (206-1) has a timestamp of Friday 11:26 a.m. In this example, the control system identifies text symbols that reflect time in the electronic content (306-1). In this example, the terms “am” and “can't” are identified as terms that reflect immediacy to time. As will be described in FIG. 4, the control system can reference the library to identify these terms in the electronic content (306-1) or the control system can use another appropriate mechanism to identify the appropriate terms.

The control system assigns time thresholds to the terms identified to reflect the time. In this example, the term “am” and “can't” are assigned a time threshold of one day. As will be described in FIG. 4, the control system can reference a library to assign a time threshold to the terms identified in the electronic content (306-1). In other examples, the terms “am” and “can't” are assigned different time thresholds.

In keeping with the given example, more electronic content (306-2) is added on Monday at 8:43 p.m. and reads “I am sad to be leaving Boston tonight.” The control system determines that an age of language in electronic content (306-2) in a display (304-2) exceeds a language change time threshold and changes the language to reflect a current time in response to exceeding the language change time threshold. The control system may determine that the language change time threshold is exceeded with a time measurement based on the time stamp generated when the language was originated. In other examples, the post on Monday at 8:43 p.m. may indicate to the control system that the language change time threshold has expired since a new post has been added. Thus, a later added post, such as the post on Monday at 8:43 p.m. may be one of multiple factors that is considered when determining that the time threshold has passed and that a tense of the language in the first posts is to be changed.

In this example, the terms “am” and “can't” are changed to “was” and “couldn't” to reflect a current time in response to exceeding the language change time threshold. As will be described in FIG. 4, the control system can reference a term library to determine a recommended change or use another mechanism to determine the appropriate change. In some cases, the appropriate change may be based on circumstances. For example, the control system may consider other factors for changing terms such as “am.” A first post may say “I am leaving Boston,” and the control system may change the post to say “I was leaving Boston” or “I left Boston” depending on the other considerations.

FIG. 4 is a diagram of an example of a library for controlling language tense in electronic content, according to one example of principles described herein. As mentioned above, the control system references a library (400) of terms (402) that reflect time. The library (400) includes a recommended time threshold (404) associated with these terms. The library (400) also includes a recommended change (406) associated with the terms.

Turning specifically to FIG. 4, the library (400) includes text symbols (402) such as “three days” (402-1), “am” (402-2), and “can't” (402-3). Although the library (400) in the example of FIG. 4 includes just three terms (402), in practice a library may contain thousands of text symbols. In this example, the terms (402) in the library (400) have a recommended time threshold (404) that can be assigned to the term in response to identifying the terms in the electronic content.

In the example of FIG. 4, the term “three days” (402-1) has a recommended time threshold (404) that has a variable time threshold. In this case, the variable time threshold expires at midnight of that day (404-1). As a result, in response to reaching midnight, the term “three days” (402-1) is changed to reflect a current time. If “three days” is originated in the morning, it will remain as “three days” longer than if “three days” was originated in the evening. Thus, the duration of the variable time threshold for “three days” varies depending on the time of day that the term is originated.

The term “three days” (402-1) has a recommended change (406) of “two days” (406-1). As a result, the control system may choose to change “three days” to “two days” as recommended by the library. In other examples, the control system may consider other factors and opt to change the term “three days” to something else based on those other factors.

The library (400) also includes the term “am” (402-2). The term “am” has a recommended time threshold (404) that depends on circumstances (404-2). The control system may consider more of the post than just the term “am” when determining the time threshold. For example, the term “am” indicates a present condition, which could last for a matter of seconds to a lifetime. For example, a post that says “I am driving to the store” may properly have a time threshold assigned to it that lasts from a couple of minutes to a couple of hours. On the other hand, a post that says “I am hoping to retire in Florida” can properly have a time threshold assigned to the term “am” that lasts from a couple of seconds to years. In yet another example, the control system may opt to not even assign a time threshold to a term “am” when the post says “I am the son of an engineer” because in this case, the term “am” does not reflect time. Thus, the library may indicate other conditions to be considered when assigning a time threshold.

A recommended time threshold (404) that depends on circumstances (404-2) may be a variable time duration threshold that expires at a specified moment in a time period. For example, a term of “today” has a longer time duration before reaching its recommended time threshold (404) if the electronic content originated in the morning rather than in the afternoon.

The term “can't” (402-3) has a recommended time threshold (404) of one hour (404-3). A one hour time threshold has a fixed duration. So, determining the expiration of this type of time threshold can be determined by measuring from the time stamp when the language originated. In this example, the term “can't” (402-3) has a recommended change (406) of “couldn't” (406-3).

FIG. 5 is a flowchart of an example of a method (500) for controlling language tense in electronic content, according to principles described herein. As mentioned above, a control system is used to control the language tense in electronic content. The method (500) for controlling language content includes determining (501) that an age of language in electronic content in a display exceeds a language change time threshold and changing (502) the language to reflect a current time in response to exceeding the language change time threshold.

Determining (501) that an age of language in electronic content exceeds a language change time threshold may include measuring a recorded time stamp when the terms originated in the electronic content to the current time. Further, to determine (501) that the age of the language in the electronic content exceeds the language change time threshold may include analyzing content of younger language in the electronic content, which is a message added later that suggests that the original message's tense should be reconsidered. For example, if a user posts on a social network service “I am going to the store” and then later posts “I am at the store.” The second post would be considered younger language because it originated later. The younger language in electronic content is analyzed to determine (501) the age of the text symbols. As a result, the control system may determine to change the language of the first post.

In yet another example, the control system may determine (501) that the age of the language in the electronic content exceeds the language change time threshold based on a user's input. For example, if the control system cannot determine the age of the recommended time threshold, the control system may prompt the user so that the control system may obtain the user's input about the age of the language in electronic content.

Additionally, a learning mechanism may be used to refine an ability to determine (501) an age of the language. The learning mechanism may also be used to determine an accuracy of the language that reflects the current time. In one example, a learning mechanism may include a voting mechanism for users to provide input about the accuracy of the changes. As a result, based on the input from users, the learning mechanism may be used to refine recommended time thresholds for text symbols contained in the library.

The control system changes (502) the language to reflect a current time in response to exceeding the language change time threshold. As mentioned above, if the control system determines a text symbol exceeds a recommended time threshold the text symbol is changed to reflect a current time. In such an example, reference to a text symbol exceeding a recommended time threshold in a library is used to determine a recommended change (502) for the text symbol.

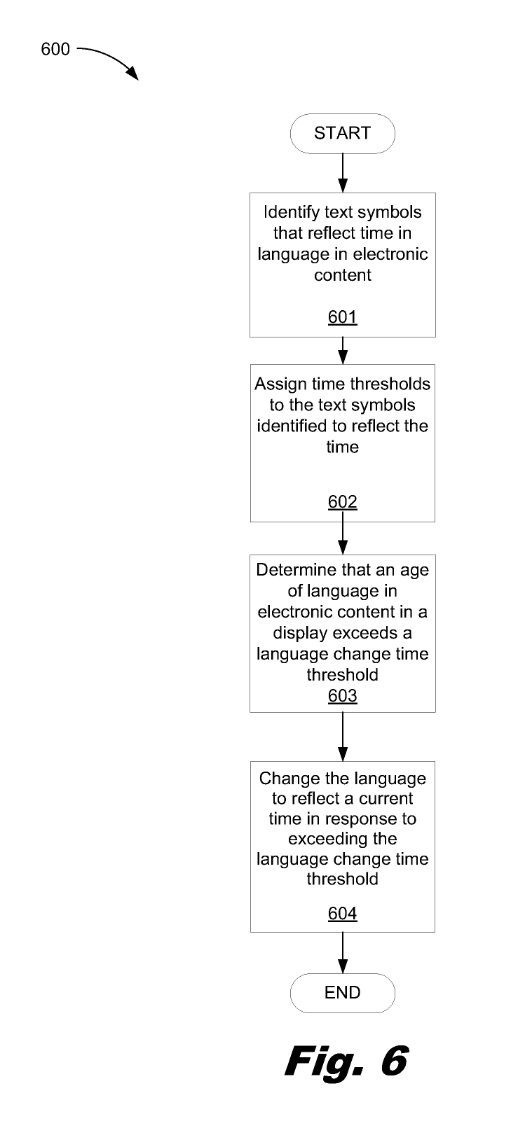

FIG. 6 is a flowchart of an example of a method (600) for controlling language tense in electronic content, according to principles described herein. As mentioned above, a control system is used to control the language tense in electronic content. The method (600) for controlling language content includes identifying (601) text symbols that reflect time in language in electronic content, assigning (602) time thresholds to the text symbols identified to reflect the time, determining (603) that an age of language in electronic content in a display exceeds a language change time threshold and changing (604) the language to reflect a current time in response to exceeding the language change time threshold.

Turning specifically to FIG. 6, as mentioned above, the method for controlling language content includes identifying (601) text symbols that reflect time in language in the electronic content. In one example, text symbols are identified (601) that reflect time in the electronic content. Text symbols are identified (601) that reflect time such as time of day terms, time of week terms, time of year terms, age terms, due date terms, verb terms, other terms, or combinations thereof. Text symbols may be identified (601) using a library that contains text symbols that reflect time as described in FIG. 4.

The control system assigns a recommended time threshold to the text symbols identified in the electronic content that reflects time. In one example, a recommended time threshold may be independent of time, have a variable time duration, or a fixed time. Further, a recommended time threshold may be determined by referencing a library. The library contains recommended time thresholds for text symbols identified in the electronic content as described in FIG. 4.

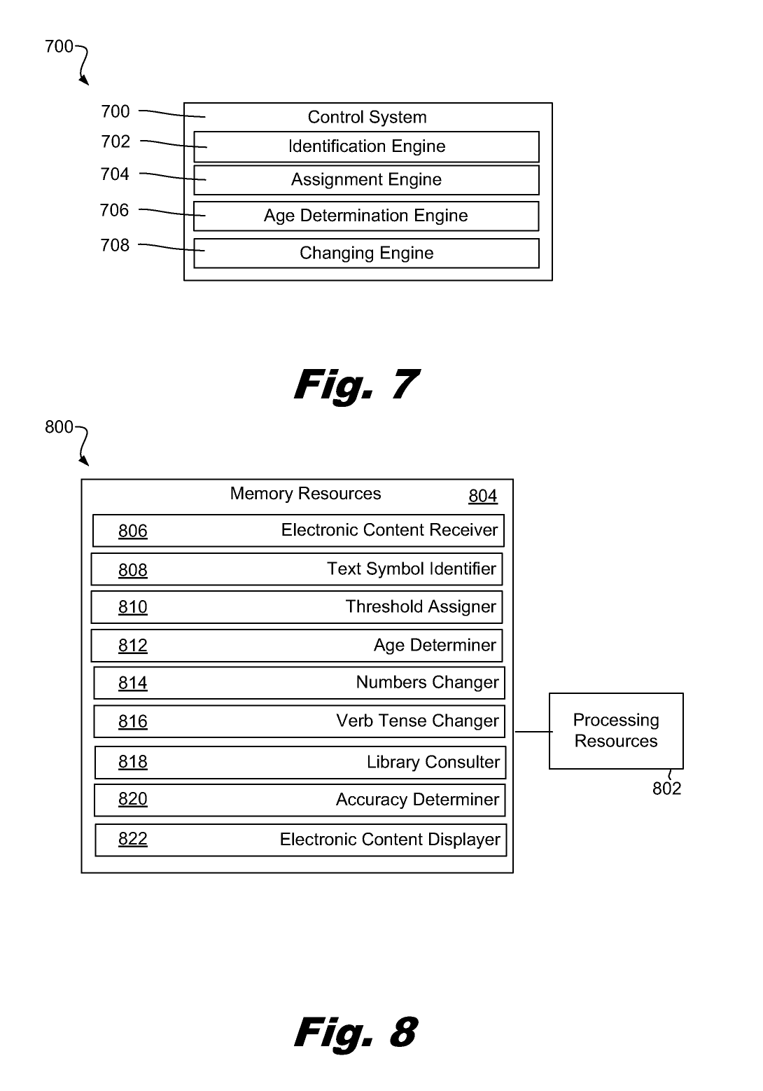

FIG. 7 is a diagram of an example of a control system (700), according to the principles described herein. The control system (700) includes an identification engine (702), an assignment engine (704), an age determination engine (706), and a changing engine (708). The engines (702, 704, 706, 708) refer to a combination of hardware and program instructions to perform a designated function. Each of the engines (702, 704, 706, 708) may include a processor and memory. The program instructions are stored in the memory and cause the processor to execute the designated function of the engine.

The identification engine (702) identifies text symbols that reflect time in electronic content in a display. Further, the identification engine (702) is in communication with a library that contains text symbols that reflect time. In one example, the identification engine (702) identifies text symbols that reflect time such as time of day terms, time of week terms, time of year terms, age terms, due date terms, verb terms, or combinations thereof.

The assignment engine (704) assigns recommended time thresholds to the text symbols identified that reflect time. Further, the assignment engine (704) is in communication with a library. The library includes a recommended time threshold for at least some of the text symbols identified in the electronic content.

The age determination engine (706) is used to determine an age of the text symbols. In one example, the age determination engine (706) determines that the age of the language in the electronic content in a display exceeds the language change time threshold by measuring a lapsed time from a timestamp recorded for the electronic content. In other examples, the language change time threshold is determined by recognizing that a change of a time unit, like a day has expired. In such an example, a message that includes the term “today” may be changed to “yesterday.” In other examples, the expiration of a time threshold is determined with another mechanism.

The changing engine (708) changes the language to reflect a current time in response to exceeding the language change time threshold. In one example, if the control system (700) determines a text symbol in electronic content exceeds a recommended time threshold, the text symbol is changed to reflect a current time. In such an example, a library is used to determine a recommended change for the text symbol. If the electronic content contains the term “three days,” “three days” is displayed in the electronic content until the term “three days” exceeds the recommended time threshold of until midnight of that day. The term “three days” is changed to “two days” to reflect the current time.

FIG. 8 is a diagram of an example of a control system (800), according to the principles described herein. In this example, the control system (800) includes processing resources (802) that are in communication with memory resources (804). Processing resources (802) include at least one processor and other resources used to process programmed instructions. The memory resources (804) represent generally any memory capable of storing data such as programmed instructions or data structures used by the control system (800). The programmed instructions shown stored in the memory resources (804) include an electronic content receiver (806), a text symbol identifier (808), a threshold assigner (810), an age determiner (812), a numbers changer (814), a verb tense changer (816), a library consulter (818), an accuracy determiner (820), and an electronic content displayer (822).

The memory resources (804) include a computer readable storage medium that contains computer readable program code to cause tasks to be executed by the processing resources (802). The computer readable storage medium may be tangible and/or physical storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, or types of memory, or combinations thereof.

The electronic content receiver (806) represents programmed instructions that, when executed, cause the processing resources (802) to receive electronic content that is to be analyzed to control language tense in the electronic content. The text symbol identifier (808) represents programmed instructions that, when executed, cause the processing resources (802) to identify text symbols that reflect time in electronic content in a display. The threshold assigner (810) represents programmed instructions that, when executed, cause the processing resources (802) to assign recommended time thresholds to the text symbols identified to reflect time. The age determiner (812) represents programmed instructions that, when executed, cause the processing resources (802) to determine an age of the identified text symbols. The numbers changer (814) represents programmed instructions that, when executed, cause the processing resources (802) to change numbers in the electronic content. The verb tense changer (816) represents programmed instructions that, when executed, cause the processing resources (802) to change the verb tense of the identified text symbols in the electronic content. The library consulter (818) represents programmed instructions that, when executed, cause the processing resources (802) to reference a library of text symbols that reflect time. The accuracy determiner (820) represents programmed instructions that, when executed, cause the processing resources (802) to determine an accuracy of the language that reflects the current time. The electronic content displayer (822) represents programmed instructions that, when executed, cause the processing resources (802) to display electronic content that reflects the current time.

Further, the memory resources (804) may be part of an installation package. In response to installing the installation package, the programmed instructions of the memory resources (804) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid-state hard drive, or the like.

In some examples, the processing resources (802) and the memory resources (804) are located within the same physical component, such as a server, or a network component. The memory resources (804) may be part of the physical component's main memory, caches, registers, non-volatile memory, or elsewhere in the physical component's memory hierarchy. Alternatively, the memory resources (804) may be in communication with the processing resources (802) over a network. Further, the data structures, such as the libraries, may be accessed from a remote location over a network connection while the programmed instructions are located locally. Thus, the recommendation system (800) may be implemented on a user device, on a server, on a collection of servers, or combinations thereof.

The control system (800) of FIG. 8 may be part of a general-purpose computer. However, in alternative examples, the control system (800) is part of an application specific integrated circuit.

The preceding description has been presented to illustrate and describe examples of the principles described. This description is not intended to be exhaustive or to limit these principles to any precise form disclosed. Many modifications and variations are possible in light of the above teaching.

The flowchart and block diagrams in the figures illustrate the architecture, functionality, and operations of possible implementations of systems, methods, and computer program products. In this regard, each block in the flowchart or block diagrams may represent a module, segment, or portion of code, which has a number of executable instructions for implementing the specific logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration and combination of blocks in the block diagrams and/or flowchart illustration, can be implemented by special purpose hardware-based systems that perform the specified functions or acts, or combinations of special purpose hardware and computer instructions.

The terminology used herein is for the purpose of describing particular examples, and is not intended to be limiting. As used herein, the singular forms “a,” “an” and “the” are intended to include the plural forms as well, unless the context clearly indicated otherwise. It will be further understood that the terms “comprises” and/or “comprising” when used in the specification, specify the presence of stated features, integers, operations, elements, and/or components, but do not preclude the presence or addition of a number of other features, integers, operations, elements, components, and/or groups thereof.

What is claimed is:

1. A computer program product for controlling language tense in electronic content, comprising:
a tangible computer readable storage medium, said tangible computer readable storage medium comprising computer readable program code embodied therewith, said computer readable program code comprising program instructions that, when executed, causes a processor to:
determine that an age of language in electronic content exceeds a language change time threshold; and
change said language to reflect a current time in response to exceeding said language change time threshold.

2. The computer program product of claim 1, further comprising computer readable program code comprising program instructions that, when executed, cause said processor to determine which text symbols of said language reflect time.

3. The computer program product of claim 1, further comprising computer readable program code comprising program instructions that, when executed, cause said processor to assign text symbols of said language independent time thresholds based on characteristics of said text symbols.

4. The computer program product of claim 1, further comprising computer readable program code comprising program instructions that, when executed, cause said processor to change a first group of text symbols of said language in response to a first expiration of a first threshold and to further change a second group of text symbols of said language in response to a second expiration of a second threshold that is different from said first threshold.

5. The computer program product of claim 1, further comprising computer readable program code comprising program instructions that, when executed, cause said processor to reference a library of text symbols that reflect time.

6. The computer program product of claim 5, wherein said library contains a recommended time threshold associated with at least some of said text symbols.

7. The computer program product of claim 6, wherein said recommended time threshold has a variable time duration and expires at a specified moment in a time period.

8. The computer program product of claim 7, wherein said specified moment in said time period is an end of a day on which said language originated.

9. The computer program product of claim 6, wherein said recommended time threshold has a fixed time duration.

10. The computer program product of claim 5, wherein said term library contains a recommended change associated with at least some of said words.

11. A system for controlling language tense in electronic content, comprising:
an identification engine to identify text symbols that reflect time in language of electronic content in a display;
an assignment engine to assign time thresholds to said text symbols identified to reflect said time;
an age determination engine to determine an age of said language; and
a changing engine to change a time expired text symbol of said text symbols to reflect a current time in response to exceeding at least one of said time thresholds.

12. The system of claim 11, wherein an identification engine is in communication with a library that contains text symbols that reflect time.

13. The system of claim 12, wherein said assignment engine is in communication with said library which also includes a recommended time threshold of at least some of said text symbols.

14. The system of claim 12, wherein said changing engine to reference to said library which contains a recommended change based on an expiration of said recommended time threshold.

15. The system of claim 11, wherein said age determination engine to further measure a recorded time stamp when said language originated in said electronic content to said current time.

16. The system of claim 11, wherein said age determination engine to further analyze younger language in said electronic content to determine said age of said terms.

17. The system of claim 11, wherein said age determination engine to further apply a learning mechanism to refine an ability of said age determination engine to determine said age.

18. The system of claim 11, wherein said changing engine to further change a first group of said text symbols in response to a first expiration of a first threshold and to further change a second group of said text symbols in response to second expiration of a second threshold that is different from said first threshold.

19. A system for controlling language tense in electronic content, comprising:
an identification engine to identify text symbols that reflect a tense of language of electronic content;
an age determination engine to determine an age of said language; and
a changing engine to change a tense of said language to reflect a current time in response to exceeding a time threshold assigned to one of said text symbols.

20. The system of claim 19, wherein said age determination engine to further analyze content of younger language in said electronic content.
